(19) United States
(12) Patent Application Publication
(10) Pub. No.: US 2018/0253756 A1
(43) Pub. Date: Sep. 6, 2018

(54) DETERMINING A SUBSIDY APPLIED BY AN ONLINE SYSTEM TO A BUDGET FOR PRESENTING CONTENT RECEIVED FROM A PUBLISING USER

(71) Applicant: Facebook, Inc., Menlo Park, CA (US)

(72) Inventors: Michael Charles Bailey, Menlo Park, CA (US); Anand Sumatilal Bhalgat, Mountain View, CA (US); Dominic Coey, Palo Alto, CA (US)

(21) Appl. No.: 15/447,640

(22) Filed: Mar. 2, 2017

(51) Int. Cl. G06Q 30/02

(52) U.S. Cl. CPC G06Q 30/0249; G06Q 50/01

(57) ABSTRACT

An online system determines a change in of revenue received when a budget for presenting content received from a publishing user is increased. Based on the change in revenue to the online system, the online system determines a subsidy that the online system can provide to one or more publishing users that increases revenue received by the online system from the publishing users, while accounting for the subsidy. To determine the change in revenue for determining the subsidy, the online system selects a subset of publishing users, increases budgets for content presentation provided by the subset of publishing users, and determines changes in revenue to the online system from the increased budgets.

This disclosure relates generally to presenting content to users of an online system, and more specifically to the online system subsidizing presentation of content items from a publishing user to users of the online system.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. An online system may also generate content for presentation to a user, such as content describing actions taken by other users on the online system.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

Often, publishing users provide the online system with budgets for presenting content items to users. A budget provided by a publishing user specifies a maximum amount of compensation the publishing user provides the online system for presenting content items from the publishing user or for interactions by users to whom content items from the publishing user were presented. The online system presents content items from the publishing user until the online system receives an amount of compensation from the publishing user that equals the specified budget. While an increased budget for presenting content items from a publishing user increases an amount of content items from the publishing user presented by the online system, presenting the increased amount of content items from the publishing user may reduce content items from other publishing users presented by the online system. This reduction in presentation of content items from other publishing users may decrease revenue received by the online system from presenting content items, despite the increased budget from the publishing user. However, increasing budgets from various publishing users may benefit both the publishing users by increasing presentation of content items from the publishing users, while also increasing revenue to the online system from the publishing users.

### SUMMARY

An online system presents various content items to its users. In various embodiments, the online system obtains content items from publishing users and includes the content items in one or more selection processes selecting content for presentation to other online system users. Publishing users also specify a budgets for presenting content items received from various publishing users. As content items received from a publishing user are presented by the online system, the publishing user provides the online system with compensation for each presentation of a content item, or for each interaction by a user with a presented content item from the publishing user. When the online system receives an amount of compensation from the publishing user that equals the budget specified by the publishing user, the online system withholds presentation of content items from the publishing user to other users. For example, after receiving an amount of compensation from the publishing user equaling the budget specified by the publishing user, the online system withholds content items from the publishing user from inclusion in selection processes selecting content for presentation to users. Hence, the budget received from a publishing user limits presentation by the online system of content items received from the publishing user.

While a publishing user increasing a budget provided to the online system increases the amount of compensation the publishing user provides to the online system, the increased budget may prevents the online system from presenting content items provided by other publishing users. Accordingly, the additional compensation received by the online system when a publishing user increases a budget is less than an amount by which the publishing user increased the budget. To increase compensation received from a publishing user while mitigating compensation lost from other publishing users because of the increased compensation form the publishing user, the online system determines a subsidy for a budget received from the publishing user that increases revenue to the online system from presenting content items from the publishing user and from other publishing users. Providing the subsidy for budgets received from one or more publishing users allows the online system to increase revenue from various publishing users while also increasing presentation of content items from various publishing users to other online system users, increasing awareness of content from various publishing users.

To determine a subsidy that increases compensation received from publishing users. In various embodiments, the online system selects a subset of publishing users from whom the online system received content items. For example, the online system selects a subset of publishing users having a particular common characteristic or having at least a threshold number of common characteristics. The online system selects the subset so a specific amount of publishing users are included in the subset (e.g., a specific percentage of publishing users, a specific number of publishing users).

For each publishing user of the subset, the online system determines a portion of a budget received by a publishing user to be increased by an amount. The online system may maintain a specific percentage of a budget to be increased by the amount. For example, the online system stores information to allocate 10% of a budget received from a publishing user to be increased by the amount. The specific percentage may be determined by the online system based on any suitable criteria or may be specified by a publishing user providing the budget to the online system. In various embodiments, the amount by which a budget is increased is a percentage of the budget. The online system may select the amount by which a budget is increased using any suitable criteria.

When selecting content for presentation to various users, the online system determines a set of users to whom content items received from publishing users of the subset are presented. Presentation of content items received from a publishing user of the subset is subject to the portion of the budget received from the publishing user of the subset increased by the amount. In various embodiments, the set of users is a percentage of users eligible to be presented with content items from the publishing users of the subset. For example, the online system maintains a percentage of users and determines the set of users as a product of the maintained percentage and a number of users eligible to be presented with content items from at least one publishing user of the subset.

Similarly, the online system determines an alternative set of users to whom content items received from publishing users of the subset are presented. The alternative set of users includes users eligible to be presented with content items from a publishing user who are not included in the set. For each publishing user of the subset, presentation of content items received from a publishing user of the subset is subject to a remaining portion of the budget received from the publishing user of the subset. The remaining portion of the budget is the budget less the determined portion of the budget, and the remaining portion of the budget is not increased. As an example, the online system determines that a portion of a budget received from a publishing user of the subset increased by the amount is 10% of the received budget, so the remaining portion of the budget is 90% of the received budget.

As the online system identifies opportunities to present content to users of the set, the online system presents content items received from publishing users of the subset. The online system includes content items received from a publishing user of the subset in selection processes that select content for presentation to users of the set for various identified opportunities to present content to users of the set until the online system while an amount of compensation received by the online system for presenting content items received from the publishing user of the subset to users of the set does not exceed the portion of the budget received from the publishing user increased by the amount. In response to the amount of compensation received by the online system from the publishing user of the subset equaling the portion of the budget received from the publishing user increased by the amount, the online system withholds content items received from the publishing user of the subset from selection processes that select content for presentation to users of the subset via subsequently identified opportunities to present content to users of the set. Accordingly, for each publishing user of the subset, the online system limits presentation of content items received from a publishing user of the subset to users of the set so the amount of compensation received by the online system does not exceed a portion of the budget received from the publishing user increased by the amount.

Similarly, as the online system identifies opportunities to present content to users of the alternative set, the online system presents content items received from publishing users of the subset. The online system includes content items received from a publishing user of the subset in selection processes that select content for presentation to users of the alternative set for various identified opportunities to present content to users of the alternative set until the online system while an amount of compensation received by the online system for presenting content items received from the publishing user of the subset for presentation of content items to users of the alternative set does not exceed the remaining portion of the budget received from the publishing user. In response to the amount of compensation received by the online system from the publishing user of the subset equaling the remaining portion of the budget received from the publishing user, the online system withholds content items received from the publishing user of the subset from selection processes that select content for presentation to users of the subset via subsequently identified opportunities to present content to users of the alternative set. Accordingly, for each publishing user of the subset, the online system limits presentation of content items received from a publishing user of the subset to users of the alternative set so the amount of compensation received by the online system does not exceed a remaining portion of the budget received from the publishing user.

The online system determines a total amount of compensation received from publishing users of the subset to users of the set and determines an additional total amount of compensation received from publishing users of the subset to users of the alternative set. In some embodiments, the online system determines the total amount of compensation and determines the additional total amount based on a specific time interval. Therefore, the total amount is based on an amount of compensation received from publishing users for presentation of content items to users of the set during the specific time interval; similarly, the additional total amount is based on an amount of compensation received from publishing users of the subset for presentation of content items to users of the alternative set during the specific time interval. In other embodiments, the total amount of compensation is determined from compensation received by the online system when at least a threshold amount of content items received from publishing users of the subset has been presented to users of the set. Similarly, the additional total amount of compensation may be determined from compensation received by the online system when at least the threshold amount of content items received from publishing users of the subset has been presented to users of the alternative set.

From the total amount and the additional total amount, the online system determines the subsidy for increasing a budget received from a particular publishing user, or for increasing budgets received from various publishing users. In some embodiments, the online system determines the subsidy based on a difference between the total amount of compensation and the additional total amount of compensation. For example, the online system calculates a difference between the total amount of compensation and the additional total amount of compensation and determines based on a ratio of the difference to a sum of the total amount of compensation and the additional total amount of compensation. In various embodiments, the online system determines the subsidy as a value that does not exceed the ratio of the difference to the sum of the total amount of compensation and the additional total amount of compensation. The subsidy is a percentage of a budget received from the particular publishing user in various embodiments; hence, the online system determines the percentage of the received budget, as described above, and increases the received budget by the determined percentage to subsidize the budget received 310 from the particular publishing user.

In various embodiments, the particular publishing user has at least a threshold number of characteristics matching characteristics of publishing users of the subset of publishing users. For example, the particular publishing user and the subset of publishing users each have least a threshold amount of common parameters for presenting content items. As another example, the particular publishing user and the subset of publishing users have at least a threshold amount of matching demographic information. Characteristics of the particular publishing user matching characteristics of the subset of publishing users may be specified by the online system 140 or by the particular publishing user in various embodiments.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment of.

FIG. 3 is a flowchart of a method for evaluating presentation of different content to users of an online system subject to allocations of a budget for content item presentation between the different content items, in accordance with an embodiment.

FIG. 4 is a conceptual diagram of an online system determining a subsidy provided by the online system for a budget from a particular publishing user for presentation of content items, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

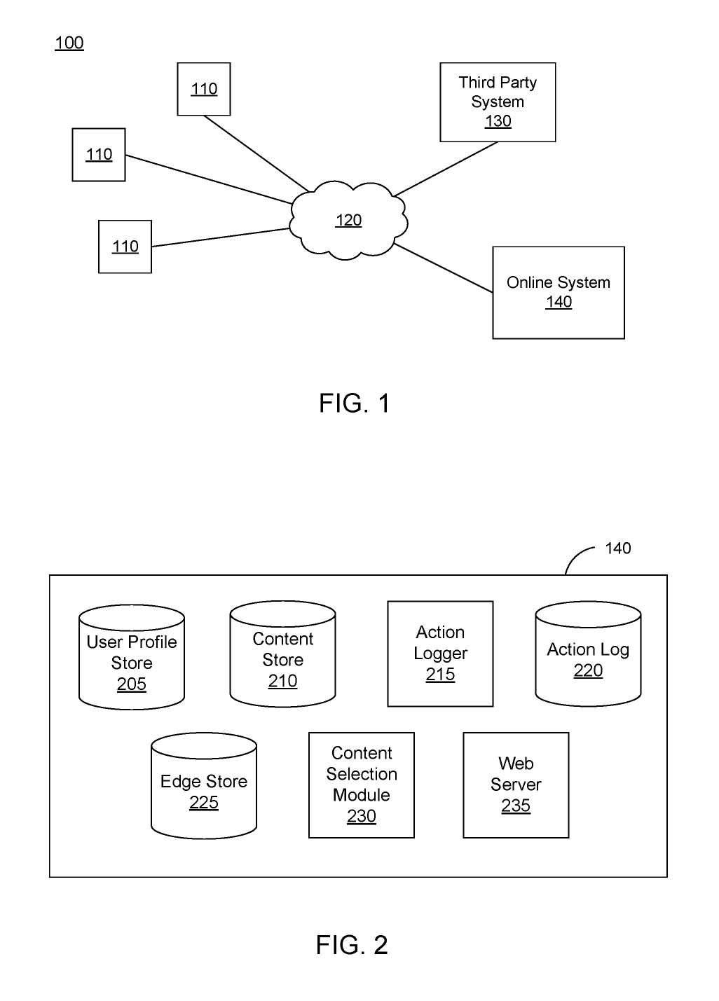

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

Various third party systems 130 provide content to users of the online system 140. For example, a third party system 130 maintains pages of content that users of the online system 140 may access through one or more applications executing on a client device 110. The third party system 130 may provide content items to the online system 140 identifying content provided by the online system 130 to notify users of the online system 140 of the content provided by the third party system 130. For example, a content item provided by the third party system 130 to the online system 140 identifies a page of content provided by the online system 140 that specifies a network address for obtaining the page of content. If the online system 140 presents the content item to a user who subsequently accesses the content item via a client device 110, the client device 110 obtains the page of content from the network address specified in the content item. This allows the user to more easily access the page of content.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image, with information identifying the images in which a user is tagged stored in the user profile of the user. A user profile in the user profile store 205 may also maintain references to actions by the corresponding user performed on content items in the content store 210 and stored in the action log 220.

Each user profile includes user identifying information allowing the online system 140 to uniquely identify users corresponding to different user profiles. For example, each user profile includes an electronic mail (“email”) address, allowing the online system 140 to identify different users based on their email addresses. However, a user profile may include any suitable user identifying information associated with users by the online system 140 that allows the online system 140 to identify different users.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In various embodiments, the content store 210 includes multiple campaigns, which each include one or more content items. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 140 provides the online system 140 with various campaigns each including content items having different characteristics (e.g., associated with different content, including different types of content for presentation), and the campaigns are stored in the content store 210 for subsequent retrieval by the content selection module 230, which is further described below.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

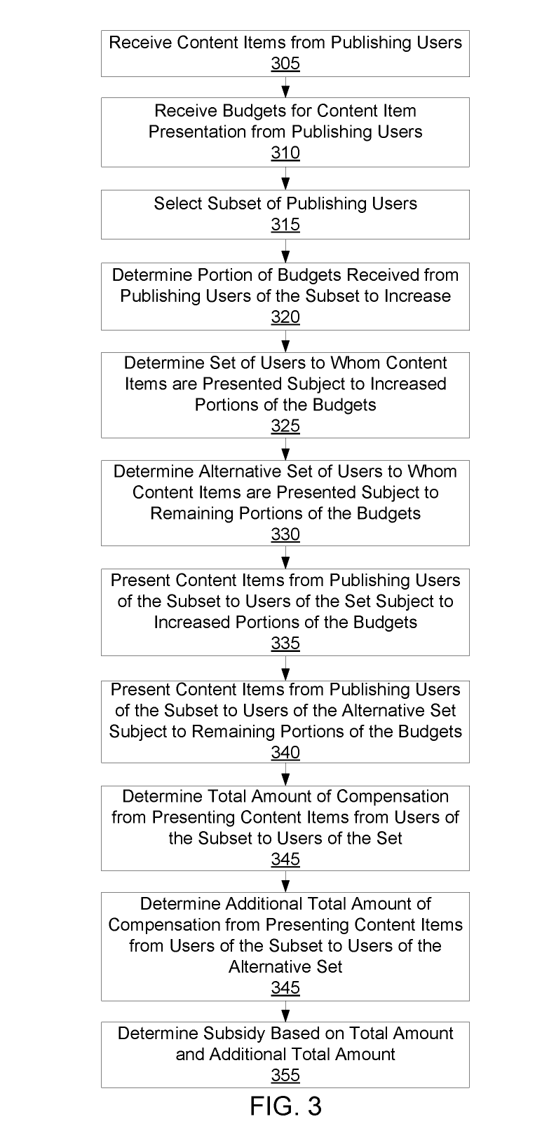

As further described below in conjunction with FIG. 3, the content selection module 230 may apply a subsidy to budgets received from various publishing users. To determine the subsidy so applying the subsidy does not reduce revenue the online system 140 receives from various publishing users. In various embodiments, the content selection module 230 selects a subset of publishing users who provided content items to the online system 140. For each publishing user of the subset, the content selection module 230 identifies a set of users eligible to be presented with content items from a publishing user and an alternative set of users eligible to be presented with content items from the publishing user. In various embodiments, the content selection module 230 identifies the set as a specified percentage of users eligible to be presented with content items from the publishing user, while the alternative set includes users eligible to be presented with content items received from the publishing user who are not included in the set.

The content selection module 230 also determines a portion of a budget received from each publishing user of the set that is increased by an amount, with the content selection module 230 presenting content items to users of the set subject to the portion of the budget increased by the amount, as further described above. As further described below in conjunction with FIG. 3, the amount is a percentage of the budget specified by the content selection module 230. The content selection module 230 presents content items to users of the set by including content items received from the publishing user in selection processes, as described above, until the online system 140 receives an amount of compensation from the publishing user for presentation of content items to users of the set that equals a portion of the budget increased by the amount. Similarly, the content selection module 230 presents content items to users of the alternative set by including content items received from the publishing user in selection processes, as described above, until the online system 140 receives an amount of compensation from the publishing user for presentation of content items to users of the alternative set that equals a remaining portion of the budget.

Based on a total amount of compensation received by the online system 140 for presenting content items from publishing users of the subset to users of the set and an additional total amount of compensation received by the online system 140 for presenting content items from publishing users of the subset to users of the alternative set, the content selection module 230 determines a subsidy. For example, the content selection module 230 determines a difference between the total amount of compensation and the additional total amount of compensation and determines the subsidy based on a ratio of the difference to a sum of the total amount of compensation and the additional total amount of compensation. As further described below in conjunction with FIG. 3, the content selection module 230 increases a budget from a particular publishing user (or publishing users) by the subsidy.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

Determining a Subsidy for a Budget for Content Item Presentation from a Publishing User

FIG. 3 is a flowchart of one embodiment of a method for determining a subsidy provided by an online system 140 to a budget from a particular publishing user for presentation of content items. In other embodiments, the method may include different and/or additional steps than those shown in FIG. 3. Additionally, steps of the method may be performed in different orders than the order described in conjunction with FIG. 3 in various embodiments.

The online system 140 receives 305 one or more content items from multiple publishing users. Each received content item is for presentation to other users of the online system 140. As further described above in conjunction with FIG. 2, a received content item is associated with a bid amount specifying an amount of compensation the online system 140 receives from a publishing user from whom the content item was received 305 in exchange for presenting the content item to other online system users or for other online system users performing one or more actions after being presented with the content item. In some embodiments, the online system 140 receives 305 multiple content items from a publishing user. The publishing user may associate different bid amounts with different content items.

Additionally, the online system 140 receives 310 a budget from each publishing user for presenting content items received 305 from a publishing user. The budget received 310 from a publishing user specifies a total amount of compensation the publishing user provides to the online system 140 for presenting content items received 305 from the publishing user to other online system users. In various embodiments, a publishing user specifies a duration in conjunction with a budget, so the budget specifies a total amount of compensation the publishing user provides the online system 140 in exchange for presenting content items from the publishing user during the duration. Hence, the budget received 310 from a publishing user limits presentation by the online system 140 of content items received from the publishing user.

While a publishing user increasing a budget provided to the online system 140 increases the amount of compensation the publishing user provides to the online system 140, the increased budget may prevents the online system 140 from presenting content items provided by other publishing users. Accordingly, the additional compensation received by the online system 140 from a publishing user increasing a budget is less than an amount by which the publishing user increased the budget. To increase compensation received from a publishing user while mitigating compensation lost from other publishing users because of the increased compensation form the publishing user, the online system 140 determines a subsidy for a budget received from the publishing user that increases revenue to the online system 140 from presenting content items from the publishing user and from other publishing users. Providing the subsidy for budgets received from one or more publishing users allows the online system 140 to increase revenue from various publishing users while also increasing presentation of content items from various publishing users to other online system users.

The online system 140 selects 315 a subset of publishing users and, for each publishing user of the subset, determines 320 a portion of the budget received 310 from the publishing user to be increased by an amount by the online system 140. For example, the online system 140 selects 315 a subset of publishing users having a particular common characteristic or having at least a threshold number of common characteristics. For example, the online system 140 selects 315 the subset of publishing users as publishing users from whom the online system 140 received a specific type of content item for presentation. As another example, the online system 140 selects 315 a subset of publishing users as publishing users who have at least a threshold amount of common demographic information. The online system 140 selects 315 the subset to include a specific amount of publishing users (e.g., a specific percentage of publishing users, a specific number of publishing users).

In various embodiments, the online system 140 maintains a specific percentage of budgets that are to be increased by the amount. For example, the online system 140 stores information to allocate 10% of a budget received 310 from a publishing user to be increased by the amount, so the online system 140 determines 320 10% of a budget received 305 from a publishing user as the portion of the budget to be increased by the amount. The specific percentage may be determined by the online system 140 based on any suitable criteria. Alternatively, a publishing user specifies a percentage or other amount of a budget provided by the publishing user to the online system 140 that the online system 140 may modify or allocate for one or more uses. In the preceding example, if the publishing user is selected 315 for the subset of publishing users, the online system 140 obtains the percentage or other amount from the publishing user (or from information associated with the publishing user) and determines 320 the portion of the budget to be increased by the amount from the obtained percentage or other amount. In various embodiments, the amount is a percentage of a budget received 310 from a publishing user of the subset. The online system 140 maintains information identifying the percentage used for the amount, and may determine the amount based on any suitable information.

When selecting content for presentation to various users, the online system 140 determines 325 a set of users to whom content items received 305 from publishing users of the subset are presented. Presentation of content items received 305 from a publishing user of the subset is subject to the portion of the budget received 310 from the publishing user of the subset increased by the amount. In various embodiments, the online system 140 determines 325 the set of users as a percentage of users eligible to be presented with content items from the publishing users of the subset. For example, the online system 140 maintains a percentage of users and determines 325 the set of users as a product of the maintained percentage and a number of users eligible to be presented with content items from at least one publishing user of the subset. Alternatively, each publishing user specifies a percentage of users; for each publishing user of the subset, the online system 140 calculates a product of the percentage specified by a publishing user of the subset and a number of users eligible to be presented with content items received 305 from the publishing user and determines 325 the set of users as a sum of the calculated products. In some embodiments, the online system 140 maintains a default percentage used by the online system 140 if a publishing user does not specify a percentage.

Similarly, the online system 140 determines 330 an alternative set of users to whom content items received 305 from publishing users of the subset are presented. For each publishing user of the subset, presentation of content items received 305 from a publishing user of the subset is subject to a remaining portion of the budget received from the publishing user of the subset. In various embodiments, the remaining portion of the budget is the budget less the determined portion of the budget. The remaining portion of the received budget is not increased by the amount. As an example, the online system 140 determines 320 that a portion of a budget received 310 from a publishing user of the subset increased by the amount is 10% of the received budget, so the remaining portion of the budget is 90% of the received budget.

As the online system 140 identifies opportunities to present content to users of the set, the online system 140 presents 335 content items received 305 from publishing users of the subset. The online system 140 includes content items received 305 from a publishing user of the subset in selection processes that select content for presentation to users of the set for various identified opportunities to present content to users of the set until the online system 140 while an amount of compensation received by the online system 140 for presenting content items received 305 from the publishing user of the subset to users of the set does not exceed the portion of the budget received 310 from the publishing user increased by the amount. In response to the amount of compensation received by the online system 140 from the publishing user of the subset equaling the portion of the budget received 310 from the publishing user increased by the amount, the online system 140 withholds content items received 305 from the publishing user of the subset from selection processes that select content for presentation to users of the subset via subsequently identified opportunities to present content to users of the set. Accordingly, for each publishing user of the subset, the online system 140 limits presentation of content items received 305 from a publishing user of the subset to users of the set so the amount of compensation received by the online system 140 does not exceed a portion of the budget received 310 from the publishing user increased by the amount.

Similarly, as the online system 140 identifies opportunities to present content to users of the alternative set, the online system 140 presents 340 content items received 305 from publishing users of the subset. The online system 140 includes content items received 305 from a publishing user of the subset in selection processes that select content for presentation to users of the alternative set for various identified opportunities to present content to users of the alternative set until the online system 140 while an amount of compensation received by the online system 140 for presenting content items received 305 from the publishing user of the subset for presentation of content items to users of the alternative set does not exceed the remaining portion of the budget received 310 from the publishing user. In response to the amount of compensation received by the online system 140 from the publishing user of the subset equaling the remaining portion of the budget received 310 from the publishing user, the online system 140 withholds content items received 305 from the publishing user of the subset from selection processes that select content for presentation to users of the subset via subsequently identified opportunities to present content to users of the alternative set. Accordingly, for each publishing user of the subset, the online system 140 limits presentation of content items received 305 from a publishing user of the subset to users of the alternative set so the amount of compensation received by the online system 140 does not exceed a remaining portion of the budget received 310 from the publishing user.

The online system 140 determines 345 a total amount of compensation received from publishing users of the subset to users of the set and determines 350 an additional total amount of compensation received from publishing users of the subset to users of the alternative set. In some embodiments, the online system 140 determines 345 the total amount of compensation and determines 350 the additional total amount based on a specific time interval. Therefore, the total amount is based on an amount of compensation received from publishing users for presentation of content items to users of the set during the specific time interval; similarly, the additional total amount is based on an amount of compensation received from publishing users of the subset for presentation of content items to users of the alternative set during the specific time interval. In other embodiments, the total amount of compensation is determined 345 from compensation received by the online system 140 when at least a threshold amount of content items received 305 from publishing users of the subset has been presented to users of the set. Similarly, the additional total amount of compensation may be determined 350 from compensation received by the online system 140 when at least the threshold amount of content items received 305 from publishing users of the subset has been presented to users of the alternative set.

From the total amount and the additional total amount, the online system 140 determines 355 a subsidy for increasing a budget received 310 from a particular publishing user, or for increasing budgets received 310 from various publishing users. In some embodiments, the online system 140 determines 355 the subsidy based on a difference between the total amount of compensation and the additional total amount of compensation. For example, the online system 140 calculates a difference between the total amount of compensation and the additional total amount of compensation and determines 355 based on a ratio of the difference to a sum of the total amount of compensation and the additional total amount of compensation. In various embodiments, the online system 140 determines 355 the subsidy as a value that does not exceed the ratio of the difference to the sum of the total amount of compensation and the additional total amount of compensation. The subsidy is a percentage of a budget received 310 from the particular publishing user in various embodiments; hence, the online system 140 determines 355 the percentage of the received budget, as described above, and increases the received budget by the determined percentage to subsidize the budget received 310 from the particular publishing user.

In various embodiments, the particular publishing user has at least a threshold number of characteristics matching characteristics of publishing users of the subset of publishing users. For example, the particular publishing user and the subset of publishing users each have least a threshold amount of common parameters for presenting content items. As another example, the particular publishing user and the subset of publishing users have at least a threshold amount of matching demographic information. Characteristics of the particular publishing user matching characteristics of the subset of publishing users may be specified by the online system 140 or by the particular publishing user in various embodiments.

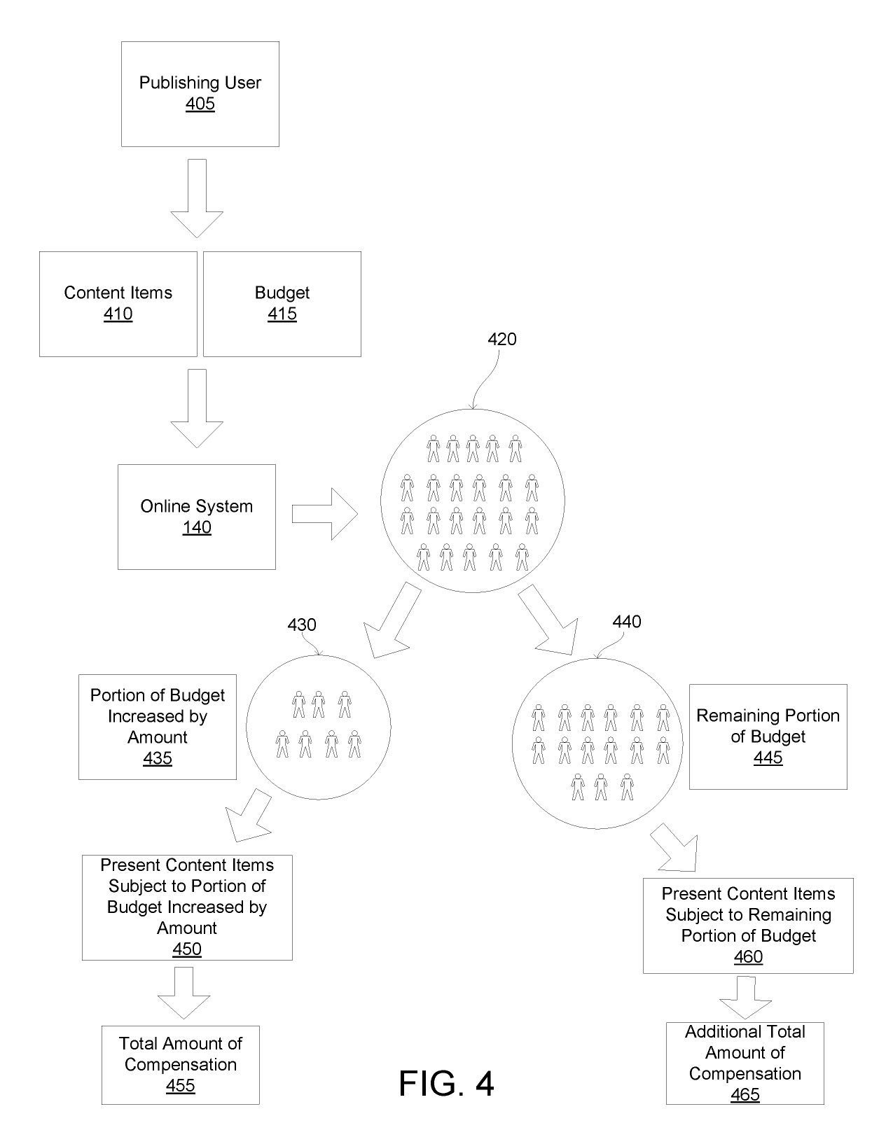

FIG. 4 is a conceptual diagram of an online system 140 determining a subsidy provided by the online system 140 for a budget from a particular publishing user for presentation of content items. For purposes of illustration, FIG. 4 shows a publishing user 405 providing content items 410 and a budget 415 for presentation of the content items 405 to an online system 140. The publishing user 405 in FIG. 4 is included in the subset of publishing users providing content items to the online system 140 described above in conjunction with FIG. 3. As described above in conjunction with FIGS. 2 and 3, the budget 415 specifies a maximum amount of compensation the publishing user 405 provides to the online system 140 in exchange for the online system 140 presenting content items 410 received from the publishing user 405 to other users or in exchange for other users interacting with the content items 410 when presented by the online system 140.

As further described above in conjunction with FIG. 3, the online system 140 uses the budgets received from the subset of publishing users of the subset, which includes the publishing user 405 in FIG. 4, and presentation of content items received from publishing users of the subset to determine a subsidy applied to budgets received from one or more particularly publishing users. The subsidy allows the online system 140 to present an increased number of content items from the particular publishing users and is determined to increase an amount of revenue online system 140 receives from a particular publishing user whose budget is increased even when accounting for the subsidy provided by the online system 140. To determine the subsidy, the online system 140 identifies users 420 eligible to be presented with the content items 410 received from the publishing user 405 and identifies a set 430 of the users and an alternative set 440 of the users. In various embodiments, the set 430 is a specified percentage of the users 420 eligible to be presented with one or more of the content items 410 received from the publishing user 405, while the alternative set 440 includes users 420 eligible to be presented with one or more content items received from the publishing user 405 who are not included in the set 430. For example, the online system 140 determines that the set 430 as including 10% of the users 420 eligible to be presented with one or more of the content items 410 received from the publishing user 405; hence, the alternative set 440 includes the remaining 90% of the users 420 eligible to be presented with one or more of the content items 410 received from the publishing user 405.

The online system 140 also determines a portion 435 of the budget 415 that is increased by an amount, with the online system 140 presenting 450 content items 410 to users of the set 430 subject to the portion 435 of the budget 415 increased by the amount. As further described above in conjunction with FIG. 3, the amount is a percentage of the budget 415 in various embodiments, and may be determined by information stored by the online system 140. Hence, the online system 140 includes content items 410 received from the publishing user 405 in selection processes that select content for presentation to users of the set 430 until the online system 140 receives an amount of compensation from the publishing user 405 for presentation of content items 410 to users of the set 430 that equals the portion 435 of the budget 415 increased by the amount. Similarly, the online system 140 presents 460 content items 410 to users of the alternative set 440 by including content items 410 received from the publishing user 405 in selection processes that select content for presentation to users of the alternative set 440 until the online system 140 receives an amount of compensation from the publishing user 405 for presentation of content items 410 to users of the alternative set 440 that equals the remaining portion 445 of the budget 415, as further described above in conjunction with FIG. 3.

Based on presentation of content items 410 to users of the set 430, the online system 140 determines a total amount of compensation 455 received from the publishing user 405 for presentation of content items 410 to users of the set 430. Similarly, the online system 140 determines an additional total amount of compensation 465 received from the publishing user 405 for presentation of content items 410 to users of the alternative set 440. In various embodiments, the total amount of compensation 455 and the additional total amount of compensation 465 are determined over a specific time interval. Alternatively, the online system 140 determines the total amount of compensation 455 and the additional total amount of compensation 465 when a specific amount (e.g., number, percentage) of content items 410 have been presented to users of the set 430 and to users of the alternative set 440. As further described above in conjunction with FIG. 3, the online system 140 determines the subsidy based on the total amount of compensation 455 and the additional total amount of compensation 465. The online system 140 subsequently applies the subsidy to a budget received from a particular publishing user, or to budgets received from one or more particular users. As further described above in conjunction with FIG. 3, the particular user has at least a threshold amount of characteristics matching characteristics of publishing users of the subset in various embodiments.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving one or more content items at an online system from a plurality of publishing users;
receiving a budget from each publishing user for presenting content items, the budget received from a publishing user specifying a total amount of compensation the publishing user provides to the online system for presenting content items the online system received from the publishing user to other users;
selecting a subset of publishing users;
for each publishing user of the subset, determining a portion of the budget from the publishing user to be increased by an amount by the online system;
determining a set of users of the online system to whom content items received from publishing users of the subset are presented subject to the portions of the budgets from the publishing users of the subset increased by the amount by the online system;
determining an alternative set of users of the online system to whom content items received from publishing users of the subset are presented subject to additional portions of the budgets received from publishing users of the subset, where the additional portions are not increased by the amount;
presenting content items received from publishing users of the subset to users of the set so amounts of compensation received by the online system for presenting the content items from the publishing user of the subset does not exceed the portion of the budget from the publishing user increased by the amount;
presenting content items received from publishing users of the subset to users of the alternative set so amounts of compensation received by the online system for presenting the content items from the publishing user of the subset does not exceed a remaining portion of the budget from the publishing user that comprises a difference between the budget received by the online system for presenting the content items from the publishing user and the portion of the budget from the publishing user;
determining a total amount of compensation received from the online system by publishing users of the subset for presenting content items from the publishing users of the subset to users of the set;
determining an additional total amount of compensation received from the online system by publishing users of the subset for presenting content items from the publishing users of the subset to users of the alternative set; and
determining a subsidy for a budget received from a particular publishing user based on a difference between the total amount of compensation and the additional total amount of compensation.

2. The method of claim 1, wherein determining the subsidy for the budget received from the particular publishing user based on the difference between the total amount of compensation and the additional total amount of compensation comprises:
determining the subsidy as a value less than a ratio of the difference to a sum of the total amount of compensation and the additional total amount of compensation.

3. The method of claim 2, wherein the subsidy comprises a percentage of a budget received from the particular publishing user.

4. The method of claim 1, wherein the particular publishing user has at least a threshold number of characteristics matching characteristics of publishing users of the subset.

5. The method of claim 1, wherein determining the set of users of the online system to whom content items received from publishing users of the subset are presented subject to the portions of the budgets from the publishing users of the subset increased by the amount by the online system comprises:
determining a percentage of users to whom content items received from one or more publishing users of the subset is eligible for presentation.

6. The method of claim 1, wherein presenting content items received from publishing users of the subset to users of the set so amounts of compensation received by the online system for presenting the content items from the publishing user of the subset does not exceed the portion of the budget from the publishing user increased by the amount comprises:
including content items received by the publishing user of the subset in one or more selection processes selecting content for presentation to users of the set until an amount of compensation received from the publishing user of the subset by the online system for presenting the content items equals the portion of the budget increased by the amount.

7. The method of claim 6, wherein presenting content items received from publishing users of the subset to users of the set so amounts of compensation received by the online system for presenting the content items from the publishing user of the subset does not exceed the portion of the budget from the publishing user increased by the amount further comprises:
withholding content items received by the publishing user of the subset in one or more selection processes selecting content for presentation to users of the set in response to the amount of compensation received from the publishing user of the subset by the online system for presenting the content items equaling the portion of the budget increased by the amount.

8. The method of claim 1, wherein presenting content items received from publishing users of the subset to users of the alternative set so amounts of compensation received by the online system for presenting the content items from the publishing user of the subset does not exceed the remaining portion of the budget from the publishing user comprises:
including content items received by the publishing user of the subset in one or more selection processes selecting content for presentation to users of the alternative set until an amount of compensation received from the publishing user of the subset by the online system for presenting the content items equals the remaining portion of the budget.

9. The method of claim 8, wherein presenting content items received from publishing users of the subset to users of the alternative set so amounts of compensation received by the online system for presenting the content items from the publishing user of the subset does not exceed the remaining portion of the budget from the publishing user further comprises:
withholding content items received by the publishing user of the subset in one or more selection processes selecting content for presentation to users of the alternative set in response to the amount of compensation received from the publishing user of the subset by the online system for presenting the content items equaling the remaining portion of the budget.

10. The method of claim 1, wherein presenting content items received from publishing users of the subset to users of the alternative set so amounts of compensation received by the online system for presenting the content items from the publishing user of the subset does not exceed the remaining portion of the budget:
including content items received by the publishing user of the subset in one or more selection processes selecting content for presentation to users of the alternative set until an amount of compensation received from the publishing user of the subset by the online system for presenting the content items equals the remaining portion of the budget.

11. The method of claim 1, wherein determining the subsidy for a budget received from the particular publishing user based on the difference between the total amount of compensation and the additional total amount of compensation comprises:
determining the subsidy based on a ratio of the difference to a sum of the total amount of compensation and the additional total amount of compensation.

12. A computer program product comprising a computer readable storage medium having instructions encoded thereon that, when executed by a processor, cause the processor to:
receive one or more content items at an online system from a plurality of publishing users;
receive a budget from each publishing user for presenting content items, the budget received from a publishing user specifying a total amount of compensation the publishing user provides to the online system for presenting content items the online system received from the publishing user to other users;
select a subset of publishing users;
for each publishing user of the subset, determine a portion of the budget from the publishing user to be increased by an amount by the online system;
determine a set of users of the online system to whom content items received from publishing users of the subset are presented subject to the portions of the budgets from the publishing users of the subset increased by the amount by the online system;
determine an alternative set of users of the online system to whom content items received from publishing users of the subset are presented subject to additional portions of the budgets received from publishing users of the subset, where the additional portions are not increased by the amount;
present content items received from publishing users of the subset to users of the set so amounts of compensation received by the online system for presenting the content items from the publishing user of the subset does not exceed the portion of the budget from the publishing user increased by the amount;
present content items received from publishing users of the subset to users of the alternative set so amounts of compensation received by the online system for presenting the content items from the publishing user of the subset does not exceed a remaining portion of the budget from the publishing user that comprises a difference between the budget received by the online system for presenting the content items from the publishing user and the portion of the budget from the publishing user;
determine a total amount of compensation received from the online system by publishing users of the subset for presenting content items from the publishing users of the subset to users of the set;
determine an additional total amount of compensation received from the online system by publishing users of the subset for presenting content items from the publishing users of the subset to users of the alternative set; and
determine a subsidy for a budget received from a particular publishing user based on a difference between the total amount of compensation and the additional total amount of compensation.

13. The computer program product of claim 12, wherein determine the subsidy for the budget received from the particular publishing user based on the difference between the total amount of compensation and the additional total amount of compensation comprises:
determine the subsidy as a value less than a ratio of the difference to a sum of the total amount of compensation and the additional total amount of compensation.

14. The computer program product of claim 13, wherein the subsidy comprises a percentage of a budget received from the particular publishing user.

15. The computer program product of claim 12, wherein the particular publishing user has at least a threshold number of characteristics matching characteristics of publishing users of the subset.

16. The computer program product of claim 12, wherein determine the set of users of the online system to whom content items received from publishing users of the subset are presented subject to the portions of the budgets from the publishing users of the subset increased by the amount by the online system comprises:
determine a percentage of users to whom content items received from one or more publishing users of the subset is eligible for presentation.

17. The computer program product of claim 12, wherein present content items received from publishing users of the subset to users of the set so amounts of compensation received by the online system for presenting the content items from the publishing user of the subset does not exceed the portion of the budget from the publishing user increased by the amount comprises:
include content items received by the publishing user of the subset in one or more selection processes selecting content for presentation to users of the set until an amount of compensation received from the publishing user of the subset by the online system for presenting the content items equals the portion of the budget increased by the amount.

18. The computer program product of claim 17, wherein present content items received from publishing users of the subset to users of the set so amounts of compensation received by the online system for presenting the content items from the publishing user of the subset does not exceed the portion of the budget from the publishing user increased by the amount further comprises:
withhold content items received by the publishing user of the subset in one or more selection processes selecting content for presentation to users of the set in response to the amount of compensation received from the publishing user of the subset by the online system for presenting the content items equaling the portion of the budget increased by the amount.

19. The computer program product of claim 12, wherein present content items received from publishing users of the subset to users of the alternative set so amounts of compensation received by the online system for presenting the content items from the publishing user of the subset does not exceed the remaining portion of the budget from the publishing user comprises:
include content items received by the publishing user of the subset in one or more selection processes selecting content for presentation to users of the alternative set until an amount of compensation received from the publishing user of the subset by the online system for presenting the content items equals the remaining portion of the budget.

20. The computer program product of claim 12, wherein determine the subsidy for a budget received from the particular publishing user based on the difference between the total amount of compensation and the additional total amount of compensation comprises:
determining the subsidy based on a ratio of the difference to a sum of the total amount of compensation and the additional total amount of compensation.
